(19) United States
(12) Patent Application Publication
(10) Pub. No.: US 2025/0024868 A1
(43) Pub. Date: Jan. 23, 2025

(54) USE OF A THERMOPLASTIC, BIOBASED AND BIODEGRADABLE MATERIAL HAVING BRITTLE FRACTURE MECHANICS AS A SHELL FOR AN EGG OR EGG-REPLACEMENT PRODUCT, AND VEGAN EGG-REPLACEMENT PRODUCT ENCASED BY SUCH A SHELL

(71) Applicants: NEGGST FOODS GMBH, Berlin (DE); FRAUNHOFER-GESELLSCHAFT ZUR FÖRDERUNG DER ANGEWANDTEN FORSCHUNG E.V., Munchen (DE)

(72) Inventors: Siegfried FÜRTAUER, Aachen (DE); Veronica GARCIA ARTEAGA, Berlin (DE); Katrin HASENKOPF, Freising (DE); Karl-Heinz JOHNEN, Aachen (DE); Dietmar OTTE, Berlin (DE); Norbert WEICHELE, Düsseldorf (DE); Jana Frederike CZERWTNSKE, Berlin (DE)

(21) Appl. No.: 18/713,281

(22) PCT Filed: Nov. 24, 2022
(86) PCT No.: PCT/EP2022/083151

§ 371 Date: May 24, 2024

(30) Foreign Application Priority Data
Nov. 25, 2021 (DE) 102021130963.8
Nov. 25, 2021 (DE) 102021130974.3
Nov. 25, 2021 (DE) 102021130977.8

(51) Int. Cl. A23L 15/00; A23J 3/22; A23L 29/00; C08K 3/26

(52) U.S. Cl. CPC A23L 15/35; A23J 3/225; A23L 29/015; A23L 29/035; C08K 3/26; C08K 2003/265; C08K 2201/018

(57) ABSTRACT

The invention relates to a use of an extruded material, including (A) one or more biodegradable, thermoplastically processable biopolymer(s) and (B) one or more inorganic, organic or low-solubility salt(s) as a shell for an egg-replacement product, and to an egg-replacement product including vegan-based egg white and egg yolk which are encased by the shell.

### FIELD OF THE INVENTION

The invention relates to a use of a material based on bio-based and biodegradable polymers, which are compounded in a suitable manner with additives, in order to use thermoplastic manufacturing processes to produce the shell for an egg or egg substitute product. The intended application is therefore a new type of packaging material for egg and egg substitute products.

### BACKGROUND OF THE INVENTION

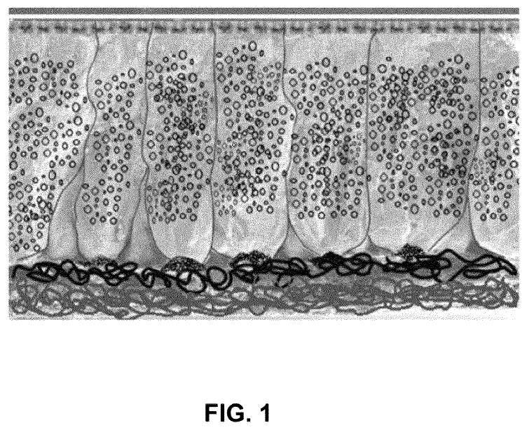

The germ cell of a chicken, including egg yolk and albumen, is surrounded by two fibrillar membranes and a calcified, partially crystalline shell. The structure of the eggshell protects the egg from mechanical damage, microbial contamination and desiccation, and regulates gas and water exchange. The eggshell consists of 95-97% calcium carbonate crystals, which are stabilized by a protein matrix. This matrix also plays an important role in the mineralization process. The crystals grow upwards like a palisade and form a porous shell (cf. FIG. 1). This complex structure cannot be reproduced artificially. A hen's egg can be between 40 mm and 50 mm in diameter, with the shell reaching a wall thickness of 340-410 μm. The maximum tensile strength in the shell of chicken eggs (measured along the longitudinal axis) is approximately 18.3-29.9 MPa. The strength of the eggshell decreases with increasing egg size, so it takes less force to break the egg. This is probably because the number and size of flaws in the microstructure of the shell increases proportionately [2], The Young's modulus of eggshells is 18-27.5 GPa. Egg shells do not have a significant gas barrier due to their porous structure and their associated function of not restricting the metabolism of a chick developing within them [3],

Naturally occurring organic-inorganic hybrid materials that occur, such as egg shells, snail shells, mussel shells, corals or bones, are characterized by high strength and hardness combined with light and material-economical construction. The outstanding mechanical properties result from a hierarchical structure of the individual components, such as inorganic components and organic matrix and can only be copied and technically reproduced with great difficulty. In isolated cases, however, materials have already been developed on a laboratory scale that come astonishingly close to the natural model. For example, a nacre-like material could be produced by alternately depositing bacterially produced CaCOs and bacterially produced polyglutamate (PGA) [4]. The hardness and fracture behavior were similar to those of natural nacre and thus superior to crystalline calcite.

However, most of the technically mature manufacturing processes are in the field of thermoplastic processing. A compounding step allows additives to be incorporated into the polymer or the particle size distribution to be adjusted. Such a compounding step is often carried out on a twin-screw extruder [5] with the goal of preparing, granulating, filling or reinforcing the plastics. The resulting granules are suitable for subsequent thermoplastic processing into the final dosage form of the material, such as extrusion, injection molding, blow molding, etc. [6], Various combinations of biopolymers and fillers as well as the properties to be expected, mostly mechanical properties, are described in the related. The type of polymer, the filler, its concentration and the temperature conditions during processing influence the final mechanical properties of the composite material.

Cinelli et al. [7] compounded polyhydroxyalkanoates (PHBV with 5% valerate content) with biobased and biodegradable plasticizer (acetyl tributyl citrate, 10%), 5% CaCO₃ and 10-30% lignocellulosic fibers (pea plant fibers, wood fibers) at 170° C. with the goal of using them for rigid, injection-molded food packaging. It was observed that with increasing fiber content, the modulus of elasticity increased while the tensile strength and elongation at break decreased. Chen et al. [8] studied the crystallization kinetics in PHBV/clay nanocomposites. The rate of crystallization of PHBV as well as its tensile strength and modulus were improved when a small amount of organically modified montmorillonite (OMMT) was added, while the opposite occurred when too much OMMT was used. A similar effect was observed by Duangphet et al. [9]. Here PHBV (3% valerate content) was compounded with 5-20% calcium carbonate and the crystallization behavior was examined. Addition of small amounts (5%) of CaCO₃ increased the rate of crystallization of PHBV. An excess of CaCO₃ (20%), on the other hand, had the opposite effect, but with the associated increased crystallite size and increased agglomeration of the CaCO₃ particles. Cabedo et al. [10] studied the influence of processing conditions on the degradation of the PHBV/clay system. While kaolin was reported to have no effect on PHBV degradation, montmorillonite (MMT) induced degradation via the release of tightly bound water from the clay surface at high temperature, which was activated by the surface modifier in the MMT. Ding et al. [11] studied P(3HB-4HB) compounds (5 mol % 4HB) with 0-80% CaCO₃ of different particle size. The thermal stability of P3/4HB was reduced with increasing CACO₃ content. Elongation at break, tensile strength and impact strength also decreased with increasing CACO₃ content; the modulus of elasticity, on the other hand, increased. The crystallization rate of P(3HB-4HB) was reduced by adding CACO₃, the highest crystallinity was reached at a CACO₃ content of 40%. Besides the mechanical properties of PHBV/CACO₃ compounds, Kirboga et al. [12] also examined other properties relevant to packaging, such as the oxygen and water vapor barrier properties. PHBV was compounded with 0.1-1% CACO₃. An improvement in rigidity (storage modulus via DMA) and an improvement in the oxygen and water vapor barrier properties could already be observed with the addition of 0.1% CACO₃. Xiong et al. [13] prepared PBS with 10-30% CACO₃ and with up to 3% (based on CACO₃) aluminate-, silane- and titanate-based compatibilizers by compounding. The goal of adding CACO₃ was to reduce costs by using less PBS. The addition of compatibilizers improved the tensile strength and elongation at break. Blends of 3:1 PLA/PBAT with 2% talc and up to 20% ground mussel powder were reported by Gigante et al. [14] described. The modulus of elasticity increased with increasing degree of filling, but the tensile strength decreased slightly. The compounds were suitable for use in injection molding. Biodegradable polymers in combination with inorganic, organic and hardly soluble fillers are also being researched and used for medical applications such as bone tissue engineering, cartilage reconstruction, vascular grafts and other implantable biomedical devices. The review by Sathiyavimal et al. [15]. Additional functions such as release of active substances or antimicrobial effect can also already be realized. Likewise will thermoplastic polymers such as polyhydroxyalkanoates, PCL, PLA, PVAc, PEO and compounds thereof with inorganic and hardly soluble fillers, such as. e.g. hydroxyapatite, calcium phosphate, bioactive glasses or wollastonite, already used as biocompatible and biodegradable materials in implants [16], The review by Rodriguez-Contreras [17] describes the medical suitability of PHB, PHBV and P(3HB-4HB) as suture material and for valves, in tissue engineering as bone graft substitutes, as cartilage, stents for nerve repair and cardiovascular patches because of their biocompatibility, biodegradability and non-toxicity.

In the field of biomedicine, there are additional manufacturing processes for composites. For example, Chemozem et al. [18] electrospun PHB and PHBV (12% valerate content) in chloroform into fibers. Subsequently, CACO₃ was deposited on the fibers by a precipitation reaction of Na₂CO₃ and CaCl₂ and the inorganic filler was introduced into the fibers by ultrasonic treatment. The goal of this study was to produce bone tissue for regenerative medicine, therefore bone forming cells (osteoblasts) were immobilized on the surface and stimulated to grow, which resulted in further biomineralization (formation of apatite). In her dissertation, Jagoda [19] describes the production of a bone replacement material from poly([R]-3-hydroxy-10-undecenoate) (PHUE), a representative of the medium-chain PHAs. This was deposited as a monolayer material on calcium phosphate. Due to its elastomeric properties, the polymer can form a flexible matrix for calcium phosphate crystals, similar to collagen in bone. Degli Esposti et al. [20] describe a process for the production of porous material from PHB and hydroxyapatite, which is based on natural bone material. PHB was dissolved in dioxane and mixed with up to 8% hydroxyapatite nanoparticles, or hydroxyapatite was produced in situ by a sol-gel process in the presence of the dissolved PHB. A porous structure was created by temperature-dependent demixing.

US 2019/263557 [21] describes an embodiment of an egg shell that is composed of two rotationally symmetrical half-shells (the plane of separation thus runs perpendicular to the longitudinal or rotational axis of symmetry of the egg), which are sealed tightly after being filled with the egg yolk. The lower half shell has an opening through which the egg white is finally added, whereby the egg is completely filled and the yolk is floating in the egg white. Finally, the filling opening of the eggshell is sealed tightly. According to the disclosure of US 2019/263557, the shell, which shall have breaking properties, gas permeability and an opaque visual appearance like a natural egg, can be made for example from “styrene-maleic anhydride (SMA)”. According to the disclosure, this material shall be biodegradable, at least by adding “oxobiodegradable” additives. The object of the application DE 103 01 984 A1 [22] from 2003 is a flexible, breathable polymer film and a corresponding manufacturing process. The film described therein is flexible and breathable and has funnel-shaped expanding pores in the surface area. Based on the model of a natural ostrich egg, a porous material that optimally implements photocatalysis is to be created, which is to be produced using a sol-gel process. However, a replacement eggshell that breaks like a natural hen's egg can probably not be produced using the polymer film described in this document.

### OBJECT OF THE INVENTION

The object of the present invention is to develop materials that have properties similar to those of mineral composite materials found in living beings in terms of color, strength, fracture behavior and biodegradability, and which retain their shape and impermeability in boiling water. Furthermore, the materials developed should have a barrier against microorganisms, oxygen, water and water vapor, as required by food packaging materials to achieve product protection. The materials should also be sterilizable (by heat or oxidizing agents such as H₂O₂) and should therefore be used primarily for egg replacement products.

### DESCRIPTION OF THE INVENTION

This object is achieved by the features of patent claims 1 and 9. Advantageous embodiments are defined in in the dependent claims.

The material or the material mixture, also called “compound” below, contains one or more biodegradable, thermoplastically processable biopolymers (A) in combination with one or more inorganic or organic and hardly soluble fillers or additives (B).

The biodegradability of the base material (A) used according to the invention is evaluated according to different standards. It corresponds to a degradation rate of at least 90% within 180 days and an achieved disintegration level of less than 10% dry mass with particles larger than 2 mm after 12 weeks, passed ecotoxicity analysis with regard to plant growth and compliance with heavy metal limits under
(semi) industrial composting conditions (e.g. according to OK compost—EN13432),
advantageously under home composting conditions (e.g. according to OK compost home—TÜV Austria Belgium),
particularly advantageous under limnic or marine degradation conditions (e.g. according to ISO 22403 or ASTM D6691-17).

The biopolymer component (A) is advantageously provided as:
One or more polyhydroxyalkanoate(s) and/or polyhydroxyalkanoate Copolymer(s), advantageously poly(3-hydroxypropionate) PHP, poly(3-hydroxybutyrate) PHB/PH3B, poly(3-hydroxyvalerate) PHV, poly(3-hydroxyhexanoate) PHHx, Poly(3-hydroxyheptanoate) PHH, Poly(3-hydroxyoctanoate) PHO, Poly(3-hydroxynonanoate) PHN, Poly(3-hydroxydecanoate) PHD, Poly(3-hydroxyundecanoate) PHIID, Poly(3-hydroxydodecanoate) PH DD, poly(3-hydroxytetradecanoate) PHTD, poly(3-hydroxypentadecanoate) PH PD, poly(3-hydroxyhexadecanoate) PHHxD; Poly(3-hydroxypropionate-co-3-hydroxybutyrate) (P3HP-3HB), Poly(3-hydroxypropionate-co-4-hydroxybutyrate) (P3HP-4HB), Poly(3-hydroxybutyrate-co-4-hydroxybutyrate) (P(3HB-4HB)), Poly(3-hydroxybutyrate-co-3-hydroxyvalerate) (PHBV), Poly(3-hydroxybutyrate-co-3-hydroxyhexanoate) (PHB-HHx), Poly(3-hydroxybutyrate-co-3-hydroxyvalerate-co-3-hydroxyhexanoate) (PHBV-HHx), medium-chain PHAs (mcl-PHA) with side chain lengths of C3-C11, long-chain PHAs (lcl-PHA) with side chain lengths greater than C12, advantageously PH3B, PHBV, PHB-HHx or (P(3HB-4HB).

### Polylactic Acid (Polylactide):

amorphous and crystalline variants of poly(L-lactide) PLLA, poly(D-lactide) PDLA, stereocomplex-(polylactide) sc-PLA, stereoblock-(polylactide) ab-PLA One or more inorganic or organic salts are suitable as filler or additive (B), advantageously
Hardly soluble salts: carbonates, sulfates, hydrogen sulfates, sulfites, sulfides, phosphates, hydrogen phosphates, oxides, hydroxides, citrates, oxalates of an alkaline earth element, the transition metals or aluminum, advantageously CaCO₃, CaSO₄, Ca₃(PO₄)₂, MgCO₃, BaSO₄, Ca-citrate, Ca-oxalate, Fe₂O₃, Al₂O₃.
Stoichiometric and non-stoichiometric double salts and hydrates and silicates, advantageously CaCO₃*MgCO₃ (dolomite), CaSO₄*2H₂O (gypsum), CaSiO₃ (wollastonite), clay minerals (e.g. montmorillonite, kaolinite, bentonite, talc), hydroxyapatite and SiO₂ in various dosage forms (e.g. silicic acids, bioactive glasses, SiO₂-based nanoparticles, etc.).

The mass fraction of filler(s) or additive (B) in the biopolymer matrix is in the range of 1-50%, advantageously 5-45%, particularly advantageously 30-45%.

The powdered or granulated biopolymer component is advantageously dehydrated by pre-drying at temperatures between 5° and 80° C. for 6-48 hours. The inorganic or organic and hardly soluble fillers are advantageously dewatered by pre-drying at temperatures between 7° and 120° C. for 6-48 hours.

The weight ratio of the components in the compounds is adjusted either by premixing the powdery components in the correct mixing ratio and advantageously subsequent extrusion or use of another thermoplastic manufacturing process, or separately feeding components of different bulk densities into the processing device, e.g. into the extruder. The temperature profile of the extruder should be set in such a way that there is no thermal degradation of the components. For this purpose it is necessary to keep the processing temperature in the range of the melting point of the polymer, typically 10-20° C. below (taking into account an additional thermal contribution through the input of mechanical energy) or 10-20° C. above (to reduce the viscosity, by to achieve an improvement in homogeneous mixing).

For PHBV as a matrix polymer (melting point 170-175° C. depending on the type), this could be a temperature profile in the lower range of 40-50° C. and in the upper range of 130-160° C., in particular 45-140-150-150-150 be ° C. For PLA as a matrix polymer (melting point 150-200° C. depending on the type), this could be a temperature profile in the lower range of 50-70° C. and in the upper range of 140-200° C., in particular 60-160-190-190-145-145-145° C.

After leaving the extruder nozzle, the compound is cooled rapidly. This can advantageously be done either via a water bath or dry ice. The finished compound can then be pelleted for further use.

Preferred combinations are
(A) Polyhydroxyalkanoates and polyhydroxyalkanoate copolymers, particularly PH3B, PHBV, PHB-HHx or (P(3HB-4HB), or polylactides, in particular PLLA or PLLA with a low D-isomer content
(B) Calcium salts, in particular CACO₃, CaSO₄, Ca₃(PO₄)₂ or Ca citrate.

Surprisingly, thin layers (<1 mm) of such compounds showed fracture properties comparable to those of naturally occurring chicken egg shells. The brittleness or the modulus of elasticity of the compounds assumed values between 3 and 8 GPa, typically between 4 and 6 GPa, and can be adjusted via the concentration of the inorganic or organic as well as hardly soluble filler. Despite the use of a thermoplastic synthetic material, these compounds still showed sufficient strength when boiled in 100° C. hot water. Furthermore, no dissolving behavior of the compound in boiling water could be observed over a period of 20 minutes. There was also no statistically significant dissolution behavior in water at room temperature and at 4° C., in 1% aqueous sodium alginate solution at room temperature and at 4° C., or in other aqueous media at room temperature and at 4° C.

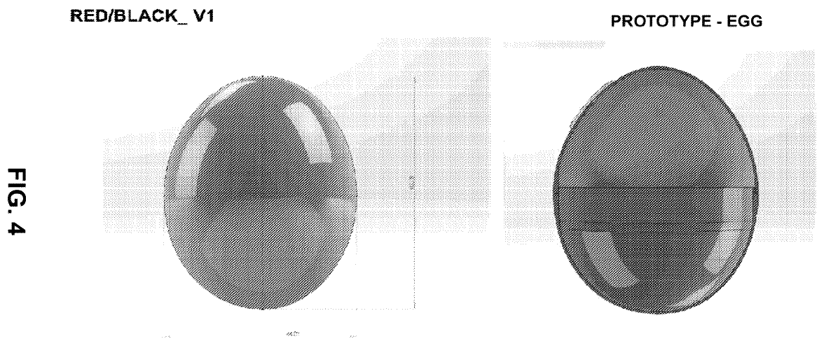

The compound is advantageously formed into two rotationally symmetrical half-shells of the same height using an injection molding process (see FIG. 4). Before the thermoplastic processing, the compound is dried at 50-80° C., advantageously between 6° and 70° C., for 6-48 hours, advantageously between 12 and 24 hours. Depending on the stability and viscosity of the melt, the temperature profile in the injection molding extruder corresponds to that of the previous compounding process, but can also be selected slightly higher if necessary. In order to ensure suitable material and heat distribution in the injection mold, the geometry of the injection point can be configured either centrally or equatorially. The volume of the egg-shaped hollow body, which results from the combination of the two half-shells, corresponds to that of a larger hen's egg and is between 50 and 70 ml, advantageously 60-65 ml. The shell thickness of the injected half-shells corresponds approximately to that of a hen's egg, between 0.5-1 mm, advantageously 0.6-0.75 mm. The surface of the outer shell of the eggshell can be either smooth or rough—this is achieved by suitable mechanical processing of the inner surface of the mold (milling, eroding, etc.). The two half-shells have a plug-in mechanism along the equator, which makes it possible to join them with a perfect fit. In the area of the plug-in connection, the shell thickness increases slightly, by a factor of about 2, in order to ensure greater mechanical stability at this location. One of the two half-shells, ideally the one at the top, which tapers somewhat narrower towards the tip, has an opening on the side in the upper third or centrally on the axis of rotation, typically between 2 and 6 mm, optimally between 3 and 5 mm, which is also formed during the injection molding process. This opening makes it possible to fill the resulting hollow body, which results from the firm connection of the two egg shell halves, with one or more flowable and conveyable components (egg white and egg yolk).

The wrapping of an egg substitute product is described infra. An egg substitute product is a vegan-based product that, like a natural animal egg, contains a separate albumen and yolk and is also structured and usable as such. Both egg white and yolk contain (a) vegetable protein from legumes, oilseeds, cereals and/or algae, and (b) a combination of at least two hydrocolloids with different behavior with temperature changes. Depending on whether it is an egg white or an egg yolk, other components are added.

“Vegan-based” means that the product contains no animal or animal-derived ingredients.

The percentages given in the text below are in each case % by weight.

In the following, the terms “egg white” and “protein” are used synonymously. For example, the vegan-based egg white substitute contains:
(a) drinking water
(b) one or more protein(s) from legumes, oilseeds, cereals, microorganisms and/or algae,
(c) a combination of one or more thermogelling hydrocolloid(s) with one or more reversibly gelling hydrocolloid(s),
(d) one or plural salt(s), wherein the proportion of the combination of one or more reversibly thermogelling hydrocolloid(s) with one or more reversibly gelling hydrocolloid(s) is 0.25-5.00% by weight.

Vegetable raw materials from the group of legumes, cereals, oilseeds, microorganisms and (micro)algae, advantageously vegetable proteins from peas (Pisum sativum), chickpeas (Cicer arientinum), garden beans (Phaseolus vulgaris), Faba beans (also known as field beans are suitable as a protein source; Vicia faba), sweet lupins (Lupinus), lentils (Lens culinaris), corn (Zea mays), hemp (Cannabis sativa), sweet potatoes (Ipomoea batatas), cassava (Manihot esculenta), potatoes (Solanum tuberosum), pumpkin (Cucurbita), flax (Linum usitatissimum), oilseed rape (Brassica napus), soya (Glycine max), oats (Avena sativa), bacteria (e.g. Lactobacillus spp., Streptococcus spp., and Bifidobacterium spp.), yeasts (e.g. Saccharomyces cerevisiae), molds (e.g. Aspergillus spp., Mucor spp., and Rhizopus spp.), nori algae and/or wakame algae, proteins from peas, chickpeas, faba beans, lupine, hemp, pumpkin and mung beans are particularly advantageous. As a protein source (raw and/or hydrolyzed and/or fermented) flours, protein concentrates, protein isolates and/or any combination thereof obtained from the plants and plant parts per se, their seeds, tubers and/or their fruits of the aforementioned raw materials can be used. The person skilled in the field of food technology is sufficiently familiar with the processing and nutritional suitability of the plants and respective plant parts.

According to the invention, a transparent white product is provided which is made from the above-mentioned proteins from one or more vegetable protein sources. The solubility of proteins is higher in salt solutions than in pure water. Therefore, a saline solution is produced from drinking water and an edible inorganic salt, advantageously a sodium chloride (NaCl) solution, to solubilize the proteins, and the protein source is dispersed therein. In principle, however, other salts are also suitable, such as sodium dihydrogen phosphate (NaH₂PO₄), disodium hydrogen phosphate (Na₂HPO₄), trisodium phosphate (NaPO₄), sodium pyrophosphate (Na₄P₂O₇) and also potassium chloride (KCl). It is of course also possible to disperse the protein source and the salt in drinking water at the same time. In some embodiments, the salt concentration, advantageously NaCl concentration, is greater than 0.05%, advantageously greater than 0.10%, greater than 0.15%, greater than 0.20%, greater than 0.30%, greater than 0.40% or greater than 0.50%. In some embodiments, the salt concentration, advantageously NaCl concentration, is 0.05%-0.80%, advantageously 0.10%-0.70%, 0.20%-0.60% or 0.4%-0.6%.

Either Kala Namak (black salt) or other salts and/or natural flavors that contain sulfur compounds can be used to create an egg-like flavor. The sulphur-containing compounds, in particular the Kala Namak salt, can be used together with the salt of the brine, advantageously NaCl, to obtain the same concentrations. However, it can also be used in smaller, larger or equal amounts.

The amount of dissolved proteins is advantageously more than 0.1%. In some embodiments, the amount of dissolved proteins is more than 1.0%, advantageously more than 2.5%, more than 4.0%, more than 5.0%, more than 8.0%, more than 10.0% % or more than 12%. In some embodiments, the amount of dissolved proteins is 0.5%-15.0%, advantageously. 1.0%-12.0%, 1.5%-10.0% or 2.0%-5.0% in the egg white substitute product according to the invention.

The egg white substitute contains hydrocolloids to set the desired viscosity and solidify when heated. A combination of one or more thermogelling hydrocolloids with one or more reversibly gelling hydrocolloids has proven to be advantageous, with the two types differing in their behavior with temperature changes. The hydrocolloids, which gel quickly when the temperature is increased to >40° C., are called “thermogelling” or “thermo-reversible gelling” and are advantageously modified celluloses methyl celluloses, hydroxyethyl celluloses, hydroxypropylmethyl celluloses (HPMC) and/or hydroxypropyl celluloses. However, the resulting gelation is only temporary: when it cools down to <40°, the gel changes back into the original viscous solution. To produce the thermogelation, a specific minimum concentration of the thermogelling hydrocolloids should be present, which is about 1.5 g/l for methylcellulose. The person skilled in the art can determine the minimum concentration for other thermogelling hydrocolloids without great experimental effort. Below this concentration, no gelation occurs when the aqueous solution is heated. Reversibly gelling hydrocolloids form gels at room temperature (approx. 20° C.) which—in contrast to thermogelling hydrocolloids—melt when heated within a certain temperature interval, i.e. liquefy and form a viscous solution which, in turn, after cooling to or below the gelling temperature gelled again.

The reversibly gelling hydrocolloids used are those from algae, advantageously carrageenan and/or agar. Other hydrocolloids, advantageously gellan gum, locust bean gum, guar gum, alginate and/or xanthan gum, are also used to set the desired consistency and support the permanent solidification of the vegan egg white. According to the invention, the amount of hydrocolloids in the albumen is less than 5.00% (e.g. less than 4.75%, 4.50%, 4.25%, 4.00%, 3.75%, 3.50%, 3, 25%, 3.00%, 2.75%, 2.50%, 2.25%, 2.00%, 1.75%, 1.50%, 1.00%, 0.75% or equal or. less than 0.50%). In some embodiments, the amount of hydrocolloids in the egg yolk replacement product is 0.10%-4.5%, (e.g. 0.20%-4.00%, 0.25%-3.00%, 0.50%-2.50% or 0.75%-2.00%). The split between thermogelling and reversibly gelling hydrocolloids is advantageously 50:50, advantageously 25:75, 30:70 or 40:60 or 75:25, 70:30 or 60:40. A level of hydrocolloids less than 5.00% allows the provision of a liquid raw egg substitute, but on the other hand provides stability and texture comparable to a hen's egg when cooked.

In some embodiments, transglutaminases can optionally be added in order to improve the texture of the protein solutions or emulsions. The effect of transglutaminases on texture lies in their ability to promote cross-linking of proteins under certain temperature and time conditions. The amount of transglutaminases is advantageously between 0.001% and 3.00%, more advantageously 0.01%-1.5%, more advantageously 0.1%-1.0%. The transglutaminases are activated while the protein solution or emulsion is at temperatures between 40° C.-60° C. for at least 15 minutes, advantageously 30 minutes, 60 minutes, 90 minutes or 120 minutes, is heated. The transglutaminase can, but need not, be microencapsulated and can advantageously be inactivated during manufacture of the egg replacement product by pasteurization or UHT treatment (above 75° C. or 120° C. respectively).

In some embodiments, vegetable oils can optionally be added to the mixture. The amount is advantageously between 0.1% and 4%, advantageously between 0.5 and 2.0%. Vegetable oils are suitable, e.g. olive oil, coconut oil, linseed oil, walnut oil, safflower oil or peanut oil; however, tasteless fats such as rapeseed oil, sunflower oil, coconut fat and/or corn oil and any combination thereof are preferred.

In order to produce a browning of the product when heated, for example when frying a “fried egg”, which is caused by a so-called Maillard reaction, a small amount of sugar is advantageously added to the product. The sugars are advantageously monosaccharides (e.g. dextrose, fructose, and/or galactose) and/or disaccharides (e.g. lactose and/or maltose). In some embodiments, the amount of sugar in the egg white is less than 1.00%, advantageously less than 0.75%, less than 0.50%, less than 0.25%, or less than 0.10%. In some embodiments, the amount of sugar in the egg white is 0.10%-1.00%, advantageously 0.25%-0.75%, 0.50%-0.50% or 0.75%-0.25%.

The egg white substitute can also contain small amounts (less than 10.0%, advantageously less than 5%, 3% or 2%) of additional minor components. These can be emulsifiers, aroma formulations (especially those containing sulfur compounds), spices, natural colorings, preservatives, thickeners or health-promoting additives. Examples include iodine, vitamins (e.g. vitamin B₁, B₂, B₃, B₅, B₇, B₉, B₁₂, C, D₃ or E), minerals (e.g. Ca or Mg) and/or plant lecithin (also acts as an emulsifier).

The egg white substitute contains essentially no carotenoids or no carotenoids at all.

The protein source(s) and the salt are dispersed in drinking water. The pH is adjusted between 6 and 9, advantageously higher than 8.0, most advantageously around 8.5, with pH food regulators such as sodium hydroxide (NaOH), potassium phosphate (K₃PO₄) or Sodium citrate (Na₃CH₅O₇). The solution is advantageously stirred for at least 1 minute, more advantageously 5-10 minutes, more advantageously 15 minutes to enhance swelling of the proteins. It is preferred, but not necessary, after swelling, to separate the proteins by suitable separation methods, advantageously centrifugation, decantation or membrane filtration. This separation results in a head containing the soluble proteins and a pellet containing the insoluble proteins. Depending on the salt concentration in the solutions used, the soluble proteins are mainly globulins and albumins. The head solution (solution (A)) is further used to make egg whites, while the residue or pellet can be used to make other products, e.g. a vegan egg yolk substitute.

According to the invention, the protein source is dispersed in water or an aqueous salt solution (solution (A)). Solution (A) can be divided into two parts ((A1) and (A2)). However, it is also possible to prepare two solutions (A1) and (A2) independently of one another: (A1) can be an aqueous protein or protein-salt solution and (A2) that of another protein or just water. Optionally, 0.001%-2.00% transglutaminase can be added to solution (A1). If unencapsulated transglutaminase is used, the solution should be kept at 50° C. for less than 120 minutes. Solution (B) is prepared by heating solution (A1) to at least 40° C., advantageously 50° C. but not more than 60° C., and adding one or more thermogelling hydrocolloids (e.g. modified cellulose, methyl cellulose and/or hydroxypropyl cellulose) manufactured. The effect of heat improves the dispersion of the hydrocolloids. Before or after dispersion of the hydrocolloids, oil (possibly containing 0.01%-50% emulsifiers), if necessary a source of calcium ions, natural dyes and if necessary other additives are mixed in solution (B). Solution (C) is prepared by mixing solution (A2) with one or more reversibly gelling hydrocolloids at a temperature below 30° C., advantageously less than 20° C., 15° C. or 10° C. In addition, natural flavors, aroma formulations, oil and (encapsulated) transglutaminase or other additives can be mixed in solution (C). Once all components of solutions (B) and (C) are fully dispersed, the solutions (B) and (C) are mixed at a temperature advantageously below 30° C., resulting in the final egg white solution (solution (D)). The solutions and dispersions described above are prepared in standard mixing vessels using known dispersion techniques.

In a second alternative embodiment, the solution (A) is not divided, but instead the reversibly gelling hydrocolloid(s) and optionally other ingredients, such as sugar and salt, are added to the solution (A). The mixture is heated to at least 40° C., advantageously 50° C., before adding the thermogelling hydrocolloid with stirring until fully dispersed. The mixture is cooled to room temperature to obtain the egg white substitute product of the present invention.

The second component of a vegan egg is the egg yolk, which contains:
(a) drinking water
(b) one or more protein(s) from legumes, oilseeds, cereals, algae or microorganisms,
(c) vegetable oil, which optionally contains at least one emulsifier,
(d) a combination of one or more reversibly thermogelling hydrocolloid(s) with one or more reversibly gelling hydrocolloid(s),
(e) at least one carotenoid-containing food and/or a natural coloring substance,
(f) optionally an at least partially pregelatinized starch, and
(g) salt, wherein the proportion of the combination of one or more reversibly thermogelling hydrocolloid(s) with one or more reversibly gelling hydrocolloid(s) is 0.5-5.0% by weight.

The product according to the invention advantageously has a protein content of between 1% and 35%, advantageously between 3% and 25% or 20%, advantageously between 4% and 15% and particularly advantageously between 5% and 12%.

Vegetable raw materials from the group of legumes, cereals, oilseeds, (micro)algae and microorganisms, advantageously peas (Pisum sativum), chickpeas (Cicer arientinum), haricot beans (Phaseolus vulgaris), faba beans (Vicia faba), sweet lupins are suitable as a protein source (Lupinus), lentils (Lens culinaris), corn (Zea mays), hemp (Cannabis sativa), sweet potatoes (Ipomoea batatas), cassava (Manihot esculenta), table potatoes (Solanum tuberosum), pumpkin (Cucurbita), flax (Linum usitatissimum), rapeseed (Brassica napus), soya (Glycine max), oats (Avena sativa), bacteria (e.g. Lactobacillus spp., Streptococcus spp., and Bifidobacterium spp.), yeasts (e.g. Saccharomyces cerevisiae), molds (e.g. Aspergillus spp., Mucor spp., and Rhizopus spp.), nori algae and/or Wakame algae, pea, lupine, potato, chickpea and Faba bean proteins are particularly advantageous. As a protein source (raw and/or hydrolyzed and/or fermented) flours, protein concentrates, protein isolates and/or any combination thereof obtained from the plants and plant parts per se, their seeds, tubers and/or their fruits of the aforementioned raw materials can be used. The person skilled in the field of food technology is sufficiently familiar with the processing and nutritional suitability of the plants and respective plant parts.

In some embodiments, transglutaminases can optionally be added in order to improve the texture of the protein solutions or emulsions. The effect of transglutaminases on texture lies in their ability to promote cross-linking of proteins under certain temperature and time conditions. The amount of transglutaminases is advantageously between 0.001% and 3.00%, more advantageously 0.01%-1.5%, more advantageously 0.1%-1.0%. The transglutaminases are activated while the protein solution or emulsion is heated to temperatures between 40° C.-60° C. for at least 15 minutes, advantageously 30 minutes, 60 minutes, 90 minutes or 120 minutes. The transglutaminase can, but need not, be microencapsulated and can advantageously be inactivated during manufacture of the egg replacement product by pasteurization or UHT treatment (above 75° C. or 120° C. respectively).

The fat content is advantageously between 1% and 50%, advantageously between 5% and 30%, very advantageously between 10% and 25% and particularly advantageously between 12% and 18%. Vegetable oils, for example olive oil, coconut oil, linseed oil, walnut oil, safflower oil or peanut oil are suitable as the fat component; however, tasteless fats such as rapeseed oil, sunflower oil, coconut fat and/or corn oil and any combination thereof are preferred. Advantageously, up to 50%. advantageously 5-40%, more advantageously 10-30%, based on the proportion of the fat component, of emulsifiers can be added to the fat component. These are, for example, lecithin (or its components such as phosphatidylcholine, phosphatidylseine, phosphatidylethanolamine or phosphatidylinositol), ascorbyl palmitate, sodium phosphate, sodium pyrophosphate, potassium phosphate, propylene glycol alginate, polyoxyethyl stearate, ammonium phosphatides, acetic acid monoglycerides, lactic acid monoglycerides, citric acid monoglycerides, tartaric acid monoglycerides, stearyl tartrate or sorbitan monostearate.

In order to give the egg yolk substitute the right color, at least one foodstuff containing carotenoids and/or natural colorings are added as a further ingredient. Preparations made from fruit, vegetables and tubers are suitable for this, advantageously from tuber and root vegetables, e.g. from carrots, apricots, tomatoes, peppers, pumpkin, fennel and/or sweet potatoes. These are advantageously boiled and mashed or finely chopped. In some embodiments, the amount of carotenoid-containing foods in the yolk is less than 15.0% (e.g., less than 12.0%, less than 8.00%, less than 4.00%, less than 2.00%, less than 1.50% or less than 0.50%). In some embodiments, the amount of carotenoid-containing foods in the yolk is 0.01%-10.0% (e.g. 0.50%-9.50%, 2.50%-7.50% or 3.00%-5.50%). It was found that the use of sweet potatoes as a food containing carotenoids surprisingly leads to the formation of a texture and color similar to the classic chicken egg yolk, with the use of sweet potatoes also supporting the protein content and fiber content and bringing a starch component into the mixture, which is advantageous affects the texture These are advantageously cooked and mashed or finely chopped. The amount of sweet potatoes can be between 3% and 10%, advantageously between 5% and 8%. If sweet potato is included as a carotenoid-containing food, the further addition of an at least partially pregelatinized starch is unnecessary (0%) or can be limited to a small amount of less than 0.5%. Otherwise, the addition of at least one (partially) pregelatinized starch is advisable, advantageously in an amount of 0.5%-4%, more advantageously 1.0%-3.0%. (Partially) pregelatinized starch is advantageously obtained from corn starch, potato starch or rice starch by mechanical processing in the presence of water with or without the application of heat. Some or all of the starch granules burst. The powder is then dried. Pregelatinized starch is a white to off-white powder and swells in cold water. It has good flow properties and is suitable as a binder.

Other suitable fruit, vegetable and tuber preparations can be used to adjust texture, mouthfeel and color. The addition of advantageously fat-soluble natural dyes such as carotenoids (e.g. 3-carotene, lycopene, zeaxanthin), carrot extracts, Curcumin and dyes that are difficult to dissolve in water, such as riboflavin. These are used individually or in combination to achieve the desired shade. In some embodiments, the amount of natural coloring in the yolk is less than 2.00% (e.g., less than 1.50%, less than 1.00%, less than 0.75%, or less than 0.25%) In some embodiments, the amount of natural coloring in the yolk is 0.01%-2.00% (e.g. 0.25%-1.75%, 1.00%-0.50% or 1.75%-0.25%). The yolk color can range from yellow to dark orange in the L*a*b* color space. The brightness (L*) can range from 70-85, advantageously from 75-80; the red-green (a*) can range from 15-30, advantageously from 19-25; the yellow-blue (b*) can be 60-95, advantageously 70-90, particularly advantageously 75-88.

Salt is added to create a chicken egg-like flavor. Advantageously NaCl, KCl, NaH₂PO₄, Na₂HPO₄, Na or K citrate, CaCl₂), Na₃PO₄ and/or Kala Namak (black salt) or a salt comparable to Kala Namak which has a portion of sulfur compounds. To this end, in some embodiments the amount of salt, advantageously Kala-Namak salt, is less than 2.00%, e.g. less than 0.75%, less than 0.50%, less than 0.25%, or less than 0.10%.

The egg yolk substitute may further contain minor amounts (less than 10.0%, advantageously less than 5%, 3% or 2%) of additional minor components. This can be flavor formulations, spices, dried vegetables or fruits, sugar, preservatives, thickeners or health-promoting additives. Examples include iodine, vitamins (e.g. vitamin B₁, B₂, B₃, B₅, B₇, B₉, B₁₂, C, D₃ or E) and/or minerals (e.g. Ca or Mg).

The egg yolk substitute contains hydrocolloids to set the desired viscosity and solidify when heated. A combination of one or more thermogelling hydrocolloids with one or more reversibly gelling hydrocolloids has proven advantageous, with the two types differing in their behavior with temperature changes. The hydrocolloids, which quickly gel when the temperature is increased to >40° C., are called “thermogelling” or “thermo-reversible gelling” and are advantageously modified celluloses, advantageously methylcelluloses, hydroxyethylcelluloses, hydroxypropylmethylcellulose (HPMC) and/or hydroxypropylcellulose. However, the resulting gelation is only temporary: the gel changes when it cools down to <40° back to the original viscous solution. To produce the thermogelation, a specific minimum concentration of the thermogelling hydrocolloids should be present, which is about 1.5 g/l for methylcellulose. The person skilled in the art can determine the minimum concentration for other thermogelling hydrocolloids without great experimental effort. Below this concentration, no gelation occurs when the aqueous solution is heated. Reversibly gelling hydrocolloids form gels at room temperature (approx. 20° C.) which—in contrast to thermogelling hydrocolloids—melt when heated within a certain temperature interval, i.e. liquefy and form a viscous solution which, in turn, after cooling to or below the gelling temperature gelled again. The reversibly gelling hydrocolloids used are those from algae, advantageously carrageenan and/or agar. Other hydrocolloids, advantageously gellan gum, locust bean gum, guar gum, alginate and/or xanthan gum, are also used to set the desired consistency and support the lasting firmness of the vegan egg yolk. In some embodiments, the amount of hydrocolloids in the egg yolk replacement product is less than 5.00% (e.g., less than 4.75%, 4.50%, 4.25%, 4.00%, 3.75%, 3.50%, 3.25%, 3.00%, 2.75%, 2.50%, 2.25%, 2.00%, 1.75%, 1.50%, 1.00%, 0.75% or equal or less than 0.50%). In some embodiments, the amount of hydrocolloids in the egg yolk replacement product is 0.10%-4.5% (e.g. 0.20%-4.00%, 0.25%-3.00%, 050% %-2.50% or 0.75%-2.00%). The split between thermogelling and reversibly gelling hydrocolloids is advantageously 50:50, advantageously 25:75, 30:70 or 40:60 or 75:25, 70:30 or 60:40. A level of hydrocolloids less than 5.00% allows providing a liquid raw egg substitute, but on the other hand provides stability and texture comparable to a hen's egg when cooked.

In a preferred embodiment, the egg yolk substitute mixture is surrounded by a shell of a highly crosslinked hydrocolloid or thermoreversibly gel-forming hydrocolloid, advantageously calcium alginate or k-carrageenan.

According to the invention, the protein source is dispersed in water or an aqueous salt solution (solution (A)). Solution (A) can be divided into two parts ((A1) and (A2)). However, it is also possible to prepare two solutions (A1) and (A2) independently of one another: (A1) can be an aqueous protein or protein-salt solution and (A2) that of another protein or just water. Optionally, 0.001%-2.00% transglutaminase can be added to solution (A1). If unencapsulated transglutaminase is used, the solution should be kept at 50° C. for less than 120 minutes. Solution (B) becomes by heating solution (A1) to at least 40° C., advantageously 50° C. but not more than 60° C., and adding one or more thermogelling hydrocolloids (e.g. modified cellulose, methyl cellulose and/or hydroxypropyl cellulose). The effect of heat improves the dispersion of the hydrocolloids. Before or after dispersion of the hydrocolloids, oil (possibly containing 0.01%-50% emulsifiers), if necessary a source of calcium ions, foodstuffs containing carotenoids or natural colorings and if necessary further additives are mixed in solution (B). Solution (C) is prepared by mixing solution (A2) with one or more reversible gelling hydrocolloids at a temperature below 30° C., advantageously less than 20° C., 15° C. or 10° C. In addition, natural flavors, aroma formulations, oil and (encapsulated) transglutaminase or other additives can be mixed in solution (C). Once all components of solutions (B) and (C) are fully dispersed, solutions (B) and (C) are mixed at a temperature advantageously below 30° C., resulting in the final egg yolk solution (solution (D)). The solutions and dispersions described above are prepared in standard mixing vessels using known dispersion techniques.

The mixture (solution (D)) can be homogenized to achieve a complete and fine distribution of the oil particles. Surprisingly, this improved both the mouthfeel, so that roughness was no longer perceptible on the tongue, and the brightness, so that fewer dyes were needed for coloring and that the product had a higher gloss. Pressures between 5 bar and 300 bar can be used for the homogenization, better between 25 bar and 225 bar and especially well between 50 bar and 250 bar. The homogenization can be in one or two stages. The independent solutions and their mixing are advantageously, but not necessarily, carried out under vacuum treatment. The vacuum can prevent air bubbles from forming in the yolk.

According to the invention, each of the solutions ((A), (B), (C) and/or (D)) can be either pasteurized or sterilized. Pasteurization/sterilization can also be complemented by other techniques such as UV and/or high pressure processing. These procedures are standard techniques that are well within the skill of the art and are amply described in the literature.

The following four methods are particularly suitable for balling an egg yolk.

### Method 1:

A soluble calcium salt (e.g. calcium lactate or calcium chloride) as part of the ingredients in solution (B) and/or (C) and the solution (B) and/or (C) is further processed as described above to provide solution (D). The solution (D) containing the calcium salt should be dosed as spherically as possible into an aqueous solution of a highly crosslinking hydrocolloid, advantageously sodium alginate, and remain in contact with this solution for a maximum of 5 minutes, advantageously less than 4 minutes and even better less than 3 minutes, so that the Filling (solution (D)) remains liquid. Solution (D) can be frozen or partially frozen in spherical forms beforehand and then added to a lukewarm bath of the highly crosslinking hydrocolloid to form capsules. Diffusion of calcium ions from the solution (D) into the solution of the highly cross-linked hydrocolloid forms an outer shell and encapsulates the egg yolk (=solution (D)) through a cross-linking reaction of the highly cross-linked hydrocolloid with the calcium ions. In other words, a surface layer forms around the solution (D), creating a shape that closely resembles a well-known animal egg yolk. The encapsulated yolk should be rinsed with water as soon as possible to stop the cross-linking reaction. The amount of hydrocolloid surrounding the solution (D) is no more than 1% of the total weight of the encapsulated yolk.

In an advantageous embodiment of method 1, the liquid “egg yolk” (solution (D)) is poured into a hydrocolloid (advantageously: sodium alginate) solution as a spherical, coherent body (weight: between 5 and 20 g) using a nozzle in a hydrocolloid (advantageously sodium alginate) solution and brought into contact with this solution for a period of less than 300 seconds, advantageously less than 240 seconds, 120 seconds or 60 seconds. The encapsulated yolk can then be rinsed in a demineralized water bath to remove excess alginate so that the ‘yolk’ does not harden during storage and remains liquid on the inside. Surprisingly, the liquid product remains so stable in its encapsulation that it can be transferred intact to a bowl/pan so that it remains curved and the liquid content only runs out after stirring/deliberate destruction of the shell.

### Method 2:

For sphere formation (encapsulation), a highly cross-linked hydrocolloid (e.g. sodium alginate) is incorporated as part of the ingredients in solution (B and/or C) and the solution (B and/or C) is processed into solution (D) as described above. The solution (D) containing the highly crosslinking hydrocolloid should be dosed as spherically as possible into an aqueous calcium salt (e.g. calcium lactate or calcium chloride) solution and remain in contact with this solution for a maximum of 5 minutes, advantageously less than 4 minutes and even better less than 3 minutes, so that the filling (solution (D)) remains liquid. Solution (D) can be pre-frozen or frozen into spherical shapes and then placed in a lukewarm calcium salt bath to form capsules. Diffusion of calcium ions from the calcium salt solution forms an outer shell and encapsulates the egg yolk (=solution (D)) through a crosslinking reaction between the highly crosslinked hydrocolloid and the calcium ions. In other words, a surface layer forms around the solution (D), creating a shape that closely resembles a well-known animal egg yolk. The encapsulated yolk should be rinsed with water as soon as possible to stop the cross-linking reaction.

Surprisingly, the liquid product remains so stable in its encapsulation that it can be transferred intact to a bowl/pan so that it remains curved and the liquid content only runs out after stirring/deliberate destruction of the shell. The amount of calcium salt surrounding the solution (D) is no more than 1% of the total weight of the encapsulated yolk.

### Method 3

For the formation of a spherical shape, the described egg yolk formulation (solution (D)) is deep frozen in suitable molds made of silicone rubber, plastic, stainless steel or similar at temperatures <0° C., typically at −18° C. and lower. The spheres or hemispheres obtained from frozen solution D with diameters between 1 and 4 cm, ideally around 2-3 cm, are then further cooled using liquid nitrogen (boiling point −196° C.) until no noticeable gas bubbles form any more on the surface of the spheres (reaching thermodynamic equilibrium). A previously prepared solution of a thermoreversibly gelling hydrocolloid, typically sodium alginate and/or k-carrageenan, is dissolved in water at temperatures above 35° C. to obtain a 1-2% clear solution. This solution is then cooled down to temperatures between 35° C. and 50° C., ideally in the range of 45-50° C. The deep-frozen balls of solution D are then immersed in the hydrocolloid solution so that a gel layer forms on the surface as a result of the cooling. The thickness of the gel layer can be adjusted by immersion time, bead size and amount of hydrocolloid solution supplied, and is 1-5 mm, typically around 1-2 mm. In other words, a surface layer is formed around the solidified solution (D), resulting in an overall shape that closely resembles a well-known animal egg yolk. Surprisingly, after thawing, the liquid product remains so stable in its encapsulation that it can be transferred intact to a bowl/pan so that it remains curved and the liquid content only runs out after stirring/destroying the shell. The amount of thermoreversibly gelling hydrocolloid surrounding the solution (D) is not more than 1% of the total weight of the encapsulated yolk.

### Method 4

For the formation of a spherical shape, the described egg yolk formulation (solution (D) without calcium ion source) is frozen in suitable molds made from silicone rubber, plastic, stainless steel or similar at temperatures <0° C., typically at −18° C. and below. If necessary, the spheres or hemispheres obtained from the frozen solution (D) with diameters between 1 and 4 cm, ideally around 2-3 cm, are then further cooled using liquid nitrogen (boiling point −196° C.) until there is no noticeable gas bubble development any more (reaching thermodynamic equilibrium) on the surface of the spheres. The surface of the spheres or hemispheres can be sprayed with calcium ions so that the ions adhere to the frozen surface. A previously prepared solution of a thermoreversibly gelling hydrocolloid, typically sodium alginate and/or k-carrageenan, is dissolved in water at temperatures above 35° C. to obtain a 1-3% clear solution. This solution is then cooled down to temperatures between 35 and 50° C., ideally in the range of 45-50° C. The deep-frozen balls, which ideally have a homogeneous layer of calcium ions on the surface, are then immersed in the hydrocolloid solution so that a gel layer forms on the surface as it cools. The thickness of the gel layer can be adjusted by immersion time, bead size and amount of hydrocolloid solution supplied, and is 1-5 mm, typically around 1-2 mm. In other words, a surface layer forms around the solidified solution (D), resulting in a shape closely resembling a well-known animal egg yolk as a whole. Surprisingly, after thawing, the liquid product remains so stable in its encapsulation that it can be transferred intact to a bowl/pan, so that it remains there in a curved position and the liquid content only flows out through stirring/destroying the shell. The amount of thermoreversibly gelling hydrocolloid surrounding the solution (D) is not more than 1% of the total weight of the encapsulated yolk.

The encapsulated yolk can be stored in a preservative and/or buffer solution containing, for example, NaCl, calcium salt, benzoic and/or ascorbic acid.

Further details on the structure and method of production of the egg white substitute product and egg yolk substitute product can be found in the applications with the application numbers 10 2021 130 963.8 and 10 2021 130 974.3, which are incorporated in their entirety by this reference.

In principle, two different methods are suitable for filling the above-described shell, which is advantageously produced by injection molding, with the egg white and egg yolk substitute: Filling variant (I) using an externally formed yolk body and filling variant (II) using in-situ formation of the yolk body.

Filling variant (1) is characterized in that it starts from an egg yolk mixture coated with crosslinked hydrocolloid, advantageously with calcium alginate. The mass of the formed yolk body is typically 20-30 g, ideally 25-29 g. The formed casing makes it possible to position the yolk body in the half-shell (see Example 3), which has no additional filling hole. The second half-shell is positioned on it by means of a plug-in connection in such a way that a hollow body including the yolk body located therein is created. In order to connect the half-shells to one another in a liquid-tight and gas-tight manner along the equator, suitable joining methods are used, which are a) through the local supply of thermal energy (heat sealing, friction welding, laser pulse welding, etc.) or b) through chemical or physical bonding of a suitable sealing medium (food-compliant and optionally biodegradable sealing wax or sealing adhesive within the plug-in connection; external application of a food-compliant and optionally biodegradable composite layer, e.g. sealing strips or spray paint). After both half-shells have been positively and irreversibly connected to each other in this way, the second component (vegan egg white) is added using a dosing system via the additional filling hole. The maximum filling height of the albumen depends on the position of the filling hole and can still be adjusted by changing the position of the egg body (e.g. tilting). The filling hole of the filled egg is closed liquid and gas-tight with suitable sealing materials, e.g. adhesive or sealing plates made of the same or different material as the shell.

The filling variant (II) is characterized in that it starts from a liquid egg yolk mixture and liquid egg white mixture. The two half-shells (see example 3) are joined liquid-tight and gas-tight along the equatorial plane when empty using suitable joining methods as recited supra. A highly cross-linked polysaccharide solution (e.g. alginate) that is not intended for final consumption is then dosed into the hollow body through the filling hole. The intended amount of egg yolk formulation is injected into this so that a thin and edible artificial yolk membrane forms at the interface between the egg yolk and the polysaccharide solution (in situ formation). After the desired membrane thickness has been reached, the remaining polysaccharide solution is removed via the filling hole by pouring out or optionally by suction, optionally washed with deionized water. The rest of the procedure (dosing the albumen, sealing the filling hole) is as described above for filling variant (I).

The invention is described in more detail with reference to drawing figures, wherein:

FIG. 1 illustrates a microscopic structure of a chicken egg shell (taken from reference [1]);

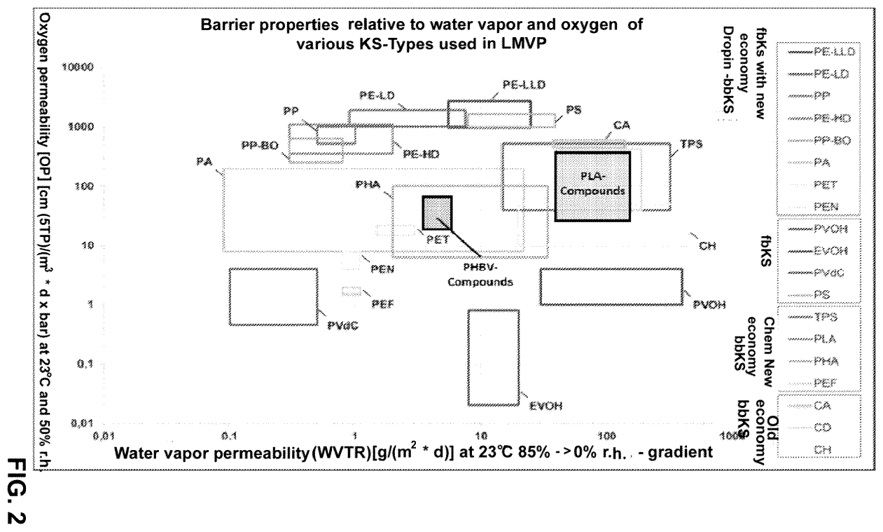

FIG. 2: illustrates water vapor and oxygen permeability of various polymers (adapted from reference [23]);

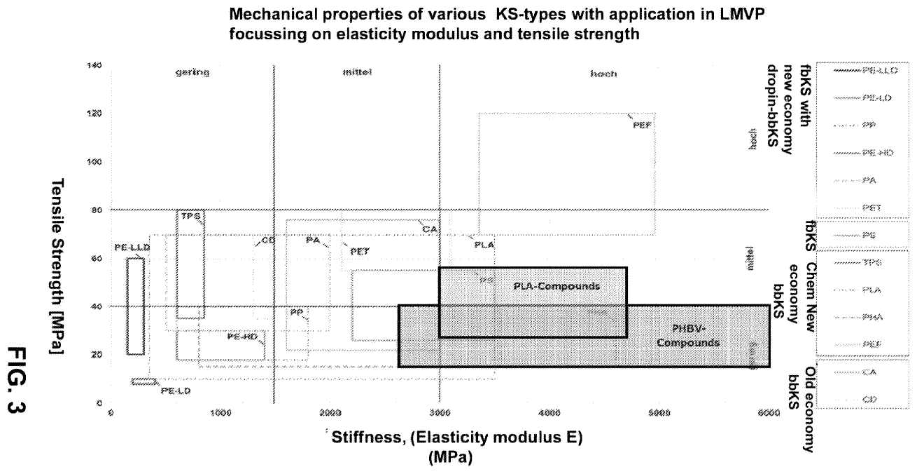

FIG. 3: illustrates tensile strength and stiffness (modulus of elasticity) of various polymers (adapted from reference [23]);

FIG. 4: Exemplary representations of the finished eggshell.

The following examples are as possible embodiments and do not represent any restriction to exactly these embodiments.

### EMBODIMENTS

### Embodiment 1; Production of Compound from PHBV and CACO₃

PHBV with a melting point of 175° C. was dried overnight at 50° C. and CACO₃ at 100° C., mixed in powder form in a ratio of 7:3 and compounded and granulated at a temperature profile of 45-140-150-150-150° C. A pressed film with a thickness of approx. 240 μm was produced from the light brown granules. The gas permeability measurement showed a water vapor permeability (WVTR, 85->0% relative humidity, 23° C.) of 1.8 g m⁻² d⁻¹ (normalized to 100 μm: 4.4 g m⁻² d⁻¹) and an oxygen permeability (OTR, 23° C./50% relative humidity) of 10.5 cm³ m⁻² d⁻¹ (normalized to 100 μm: 67.2 cm³ m⁻² d⁻¹). The mechanical tensile test showed a tensile strength of 21.6 MPa, an elongation at break of 1.1% and a modulus of elasticity of 2.9 GPa.

### Embodiment 2: Production of Compound from PLLA and CaCO₃

PLLA with low proportion of D-isomers (melting point 160° C.) was dried at 60° C. and CaCO₃ at 100° C. overnight, mixed in powder form in a ratio of 8:2 and at a temperature profile of 60-160-190-190-145-145-145° C. compounded and granulated. A pressed film with a thickness of approx. 200 μm was produced from the whitish granules. The gas permeability measurement showed a water vapor permeability (WVTR, 85->0% relative humidity, 23° C.) of 11 gm⁻² d⁻¹ (normalized to 100 μm: 22 g m² d⁻¹) and an oxygen permeability (OTR, 23° C./50% relative humidity) of 75 cm³ m⁻² d⁻¹ (normalized to 100 μm: 150 cm³ m⁻² d⁻¹). The mechanical tensile test showed a tensile strength of 40 MPa, an elongation at break of 1.0% and a modulus of elasticity of 4 GPa.

FIGS. 2 and 3 show a comparison of the achieved permeation and mechanical properties of the compounds of embodiments 1 and 2 to standard polymers for food packaging.

### Embodiment 3: Structure and Shape of the Shell

The compound from embodiment 1 is formed into two rotationally symmetrical half-shells of the same height through an injection molding process (see FIG. 4). Before thermoplastic processing, the compound is dried at 50-80° C. for 6-48 hours. Depending on the stability and viscosity of the melt, the temperature profile in the injection molding extruder corresponds to that of the previous compounding process, but can also be selected slightly higher if necessary. In order to ensure suitable material and heat distribution in the injection mold, the geometry of the injection point can be configured either centrally or equatorially. The volume of the egg-shaped hollow body, which results from the combination of the two half-shells, corresponds to that of a larger hen's egg and is between 60-65 ml. The shell thickness of the injected half-shells corresponds approximately to that of a hen's egg, i.e. approx. 0.6-0.75 mm. The two half-shells have a plug-in mechanism along the equator, which makes it possible to join them with a perfect fit. In the area of the plug-in connection, the shell thickness increases slightly, by a factor of about 2, in order to ensure greater mechanical stability here. One of the two half-shells, ideally the one at the top, which narrows towards the tip, has an opening of between 3 and 5 mm on the side in the upper third or centrally on the axis of rotation, which is formed during the injection molding process. This opening makes it possible to fill the resulting hollow body, which results from the firm connection of the two egg shell halves, with one or more flowable and conveyable components (egg white and optionally egg yolk).

### BIBLIOGRAPHY

1. Arias, J. L., et al., Eggshell Growth and Matrix Macromolecules. Handbook of Biomineralization, 2008.
2. Hahn, E. N., et al., Nature's technical ceramic: the avian eggshell. Journal of the Royal Society Interface, 2017. 14(126).
3. Lomholt, J. P., The Development of the Oxygen Permeability of the Avian Egg Shell and Its Membranes during Incubation. Journal of Experimental Zoology, 1976. 198(2): p. 177-184.
4. Spiesz, E. M., et al., Bacterially Produced, Nature-inspired Composite Materials. Small, 2019. 15(22): p. 1805312.
5. Jost, V., Effect of additives on the mechanical and permeation properties of biopolymer films from alginate and PHBV PhD, 2019. TU Munich: Freising
6. Hochrein, T. and I. Alig, Prozessmesstechnik in der Kunststoffaufbereitung 2011, Würzburg: Vogel Buchverlag.
7. Cinelli, P., et al., Biocomposites Based on Polyhydroxyalkanoates and Natural Fibers from Renewable Byproducts. Applied Food Biotechnology, 2019. 6(1): p. 35-43.
8. Chen, G. X., et al., Crystallization kinetics of poly(3-hydroxybutyrate-co-3-hydroxyvalerate)/clay nanocomposites. Journal of Applied Polymer Science, 2004. 93(2): p. 655-661.
9. Duangphet, S., et al., Effect of Calcium Carbonate on Crystallization Behavior and Morphology of Poly(3-Hydroxybutyrate-co-3-Hydroxyvalerate). Key Engineering Materials, 2017. 751: p. 242-251.
10. Cabedo, L, et al., Studying the degradation of polyhydroxybutyrate-co-valerate during processing with clay-based nanofillers. Journal of Applied Polymer Science, 2009. 112(6): p. 3669-3676.
11. Ding, Y., et al., Mechanical properties, thermal stability, and crystallization kinetics of poly(3-hydroxybutyrate-co-4-hydroxybutyrate)/calcium carbonate composites. Polymer Composites, 2011. 32(7): p. 1134-1142.
12. Kirboga, S. and M. Öner, The properties of PHBV/CaCO3 composites prepared by melt processing, in 6th International Conference on New Trends in Chemistry. 2020. virtual.
13. Xiong, L, et al., Preparation of PBS and CaCO₃ Composite Degradable Materials based on Melt Blending. IOP Conference Series: Materials Science and Engineering, 2020. 730: p. 012012.
14. Gigante, V., et al., Evaluation of Mussel Shells Powder as Reinforcement for PLA-Based Biocomposites. International Journal of Molecular Sciences, 2020. 21(15).
15. Sathiyavimal, S., et al., Natural organic and inorganic-hydroxyapatite biopolymer composite for biomedical applications. Progress in Organic Coatings, 2020. 147: p. 105858.
16. Misra, S. K., et al., Polyhydroxyalkanoates (PHA)/Inorganic Phase Composites for Tissue Engineering Applications. Biomacromolecules, 2006. 7(8): p. 2249-2258.
17. Rodriguez-Contreras, A., Recent Advances in the Use of Polyhydroyalkanoates in Biomedicine. Bioengineering, 2019. 6(3).
18. Chemozem, R. V., et al., Piezoelectric 3-D Fibrous Poly(3-hydroxybutyrate)-Based Scaffolds Ultrasound-Mineralized with Calcium Carbonate for Bone Tissue Engineering: Inorganic Phase Formation, Osteoblast Cell Adhesion, and Proliferation. ACS Applied Materials & Interfaces, 2019. 11(21): p. 19522-19533.
19. Jagoda. A., Polyhydroxyalkanoate-based thin films: characterization and optimization for calcium phosphate crystallization PhD, 2013. University of Basel: Basel
20. Degli Esposti, M., et al., Highly porous PHB-based bioactive scaffolds for bone tissue engineering by in situ synthesis of hydroxyapatite. Materials Science and Engineering: C, 2019. 100: p. 286-296.
21. Kulman, D. Imitation egg product 2019. US20190263557A1.
22. Fink, D., et al., Flexible, atmungsaktive Polymerfolie und Verfahren zu deren Herstellung 2003. DE10301984A1.
23. Detzel, A., et al., Biobasierte Kunststoffe al Verpackung von Lebensmitteln, Heidelberg, Freising, Berlin, 2018.

1. A use of a material made from
(A) one or more biodegradable, thermoplastically processable biopolymer(s), and
(B) one or more inorganic, organic or hardly soluble salt(s) as a shell for an egg replacement product.

2) The use according to claim 1, wherein the material is produced from components (A) and (B) by extrusion.

3) The use according to claim 1 or 2, wherein the biopolymer (A) is characterized by a degradation rate of at least 90% within 180 days, an achieved disintegration level of less than 10% dry mass with particles larger than 2 mm after 12 weeks and/or passed ecotoxicity analysis regarding plant growth.

4) The use according to one of claims 1-3, wherein the biopolymer (A) is a polyhydroxyalkanoate, polyhydroxyalkanoate copolymer or polylactide.

5) The use according to one of claims 1-4, wherein the salt (B) is a carbonate, sulfate, hydrogen sulfate, sulfite, sulfide, phosphate, hydrogen phosphate, oxide, hydroxide, citrate or oxalate of an alkaline earth element, a transition metal or aluminum.

6. The use according to one of claims 1-5, wherein the salt (B) is CaCO₃, CaSO₄, Ca₃(PO₄)₂, MgCO₃, BaSO₄, Ca-citrate, Ca-oxalate, Fe₂O₃ or Al₂O₃.

7. The use according to one of the claims 4-6, wherein the polyhydroxyalkanoate and/or the polyhydroxyalkanoate copolymer is a poly(3-hydroxypropionate), poly(3-hydroxybutyrate), poly(3-hydroxyvalerate), poly(3-hydroxyhexanoate), poly(3-hydroxyheptanoate), poly(3-hydroxyoctanoate), poly(3-hydroxynonanoate), poly(3-hydroxydecanoate), poly(3-hydroxyundecanoate), poly(3-hydroxydodecanoate), poly(3-hydroxytetradecanoate), poly(3-hydroxypentadecanoate), poly(3-hydroxyhexadecanoate); poly(3-hydroxypropionate-co-3-hydroxybutyrate), poly(3-hydroxypropionate-co-4-hydroxybutyrate), poly(3-hydroxybutyrate-co-4-hydroxybutyrate), poly(3-hydroxybutyrate-co-3-hydroxyvalerate), poly(3-hydroxybutyrate-co-3-hydroxyhexanoate), poly(3-hydroxybutyrate-co-3-hydroxyvalerate-co-3-hydroxyhexanoate), medium chain PHAs with side chain lengths of C₃-C₁₁ or long chain PHAs with side chain lengths greater than C₁₂.

8. The use according to one of the claims 4-6, wherein the polylactide is an amorphous or crystalline variant of poly (L-lactide) PLLA, poly (D-lactide) PDLA, stereocomplex (polylactide) sc-PLA, stereoblock (polylactide) sb-PLA.

9. An egg substitute product, comprising:
an egg white and egg yolk on a vegan basis, enveloped by a shell made from a material produced by extrusion from (A) one or more biodegradable, thermoplastically processable biopolymer (s), and (B) one or more inorganic, organic or hardly soluble salt(s),
wherein both albumen and yolk include (a) vegetable protein from legumes, oilseeds, cereals and/or algae, and (b) a combination of at least two hydrocolloids with a different reaction to temperature changes.
